(19) United States
(12) Patent Application Publication
(10) Pub. No.: US 2008/0312455 A1
(43) Pub. Date: Dec. 18, 2008

(54) Method For Determining Enantiomeric Purity Of Darifenacin And Intermediates

(75) Inventors: Nuria Soldevilla Madrid, Barcelona (ES); Jordi Bosch i Llado, Girona (ES)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Medichem, S.A., Sant Joan Despi (ES)

(21) Appl. No.: 12/138,781

(22) Filed: Jun. 13, 2008

Related U.S. Application Data
(60) Provisional application No. 60/934,883, filed on Jun. 15, 2007.

(51) Int. Cl. C07D 405/06

(52) U.S. Cl. 548/525

(57) ABSTRACT

The present invention relates to a method for differentiating and quantifying the enantiomers, thereby determining the enantiomeric purity, of darifenacin and its intermediate compounds and salts thereof. In addition, the invention relates to a method for differentiating and quantifying the enantiomers, thereby determining the enantiomeric purity of compounds of formula (I):

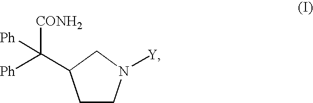

wherein Y is hydrogen or a substituent of the formula:

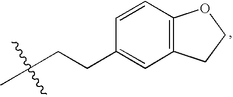

including the differentiation and quantification of compounds of formula (I) of varying enantiomeric purity from their corresponding enantiomers. The invention further relates to a process for preparing enantiomerically pure darifenacin using enantiomerically pure starting compounds which have been previously differentiated and quantified according to the method of the invention.

### CROSS-REFERENCE TO RELATED APPLICATIONS

This patent application claims the benefit of U.S. Provisional Patent Application No. 60/934,883, filed Jun. 15, 2007, which is incorporated by reference.

### BACKGROUND OF THE INVENTION

Darifenacin is the international common accepted name for (S)-2-{1-[2-(2,3-dihydrobenzofuran-5-yl)ethyl]-3-pyrrolidinyl}-2,2-diphenylacetamide, and is an active pharmaceutical substance indicated for the treatment of overactive bladder with symptoms of urge urinary incontinence, urgency and frequency. Darifenacin is commercialized as the hydrobromide salt having an empirical formula of C₂₈H₃₀N₂O₂.HBr and the following structure:

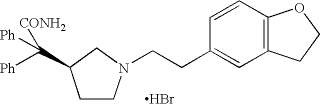

Darifenacin and its pharmaceutically acceptable salts are reported in U.S. Pat. No. 5,096,890 (“the '890 patent”). In addition, a stable hydrate of darifenacin, as well as a toluene solvate of darifenacin, are reported in International Patent Publication No. WO 03/080599 A1 (“the '599 publication”). Both the '890 patent and the '599 publication are incorporated herein by reference.

A synthesis of darifenacin hydrobromide disclosed in the '890 patent is shown in Scheme 1.

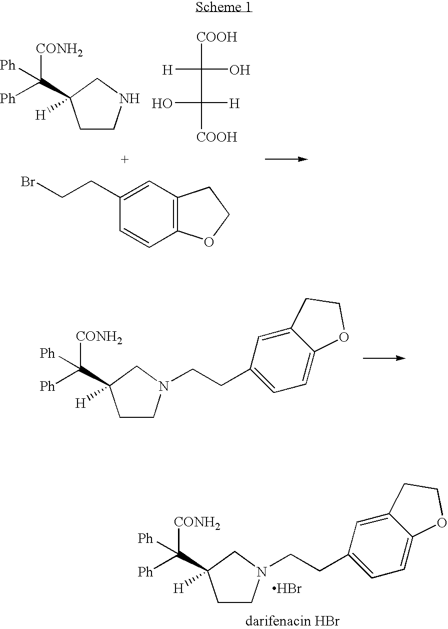

Since the eutomer of darifenacin is the (S)-enantiomer, in order to obtain enantiomerically pure darifenacin hydrobromide using this approach, it is necessary to have enantiomerically pure intermediate compounds, for example, 2,2-diphenyl-2-[(3S)-pyrrolidin-3-yl]acetamide, or any salt thereof (e.g., tartrate).

However, no methods for differentiating and quantifying the (R)- and (S)-enantiomers of darifenacin hydrobromide and their intermediate compounds are described in the literature.

Further, the reported values for the optical rotation of darifenacin are conflicting. For example, the '890 patent reports the optical rotation of darifenacin hydrobromide to be [α]_{D}²⁵−30.3° (c=1.0, CH₂Cl₂), whereas the '599 publication reports the optical rotation for darifenacin hydrobromide to be [α]₅₈₉²⁵+46.0° (no data given for concentration or solvent).

Accordingly, since the eutomer of darifenacin is the (S)-enantiomer, there exists a need to develop a reliable and reproducible method for differentiating and quantifying the (R)- and (S)-enantiomers of darifenacin hydrobromide and its intermediate compounds, thereby determining their enantiomeric purity.

### BRIEF SUMMARY OF THE INVENTION

In one embodiment, the invention provides a method for differentiating and quantifying the enantiomers, thereby determining the enantiomeric purity, of compounds of formula (I):

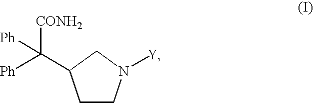

or salts thereof, wherein Y is hydrogen or a substituent of the formula:

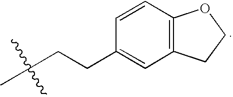

The present invention also provides a method for differentiating and quantifying the enantiomers, thereby determining the enantiomeric purity, of darifenacin and its intermediate compounds and salts thereof.

In other embodiments, the invention provides a method for differentiating and quantifying (S)-2-{1-[2-(2,3-dihydrobenzofuran-5-yl)ethyl]-3-pyrrolidinyl}-2,2-diphenylacetamide and 2,2-diphenyl-2-[(3S)-pyrrolidin-3-yl]acetamide, or salts thereof from their corresponding enantiomers. The invention includes the differentiation and quantification of (S)-2-{1-[2-(2,3-dihydrobenzofuran-5-yl)ethyl]-3-pyrrolidinyl}-2,2-diphenylacetamide and 2,2-diphenyl-2-[(3S)-pyrrolidin-3-yl]acetamide, or salts thereof, of varying enantiomeric purity. The invention further provides a process for preparing (S)-2-{1-[2-(2,3-dihydrobenzofuran-5-yl)ethyl]-3-pyrrolidinyl}-2,2-diphenylacetamide and salts thereof, for example, darifenacin hydrobromide.

The invention further provides a process for preparing enantiomerically pure darifenacin using enantiomerically pure starting compounds which have been previously differentiated and quantified according to the method of the invention.

### BRIEF DESCRIPTION OF THE DRAWINGS

FIG. 1 is a HPLC chromatogram of a reference sample comprising 2,2-diphenyl-2-[(3S)-pyrrolidin-3-yl]acetamide tartrate and 2,2-diphenyl-2-[(3R)-pyrrolidin-3-yl]acetamide tartrate analyzed using a CHIRACEL® OD-RH column and the chromatographic conditions described in Example 1.

FIG. 2 is a HPLC chromatogram of a sample comprising 2,2-diphenyl-2-[(3S)-pyrrolidin-3-yl]acetamide tartrate as a major component analyzed using the chromatographic conditions described in Example 1.

FIG. 3 is a HPLC chromatogram of a sample comprising 2,2-diphenyl-2-[(3R)-pyrrolidin-3-yl]acetamide tartrate as a major component analyzed using the chromatographic conditions described in Example 1.

FIG. 4 is a HPLC chromatogram of a racemic mixture comprising 2-{1-[2-(2,3-dihydrobenzofuran-5-yl)ethyl]-3-pyrrolidinyl}-2,2-diphenylacetamide hydrobromide analyzed using a CHIRALPAK IA® column and the chromatographic conditions described in Example 2.

FIG. 5 is a HPLC chromatogram of a sample comprising the (S)-enantiomer of 2-{1-[2-(2,3-dihydrobenzofuran-5-yl)ethyl]-3-pyrrolidinyl}-2,2-diphenylacetamide hydrobromide analyzed using the chromatographic conditions described in Example 2.

FIG. 6 is a HPLC chromatogram of a sample comprising the (R)-enantiomer of 2-{1-[2-(2,3-dihydrobenzofuran-5-yl)ethyl]-3-pyrrolidinyl}-2,2-diphenylacetamide hydrobromide analyzed using the chromatographic conditions described in Example 2.

FIG. 7 is a HPLC chromatogram of a sample comprising both enantiomers of darifenacin hydrobromide analyzed using a CHIRALPAK IA® column and the chromatographic conditions described in Example 4.

FIG. 8 is a HPLC chromatogram of a sample comprising the (S)-enantiomer of darifenacin hydrobromide analyzed using the chromatographic conditions described in Example 4.

FIG. 9 is a HPLC chromatogram of a sample comprising the (R)-enantiomer of darifenacin hydrobromide analyzed using the chromatographic conditions described in Example 4.

### DETAILED DESCRIPTION OF THE INVENTION

In one embodiment, the invention provides a method for differentiating and quantifying the enantiomers, thereby determining the enantiomeric purity, of a compound of formula (I):

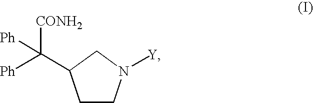

or a salt thereof, wherein Y is hydrogen or a substituent of the formula:

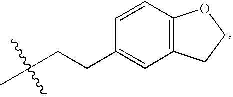

comprising: a) preparing a sample comprising a compound of formula (I); b) introducing the sample to a chiral high performance liquid chromatography column comprising a stationary phase capable of separating enantiomers of the compound of formula (I), wherein the enantiomers of the compound of formula (I) are compounds of the formula (II) and (III) or salts thereof:

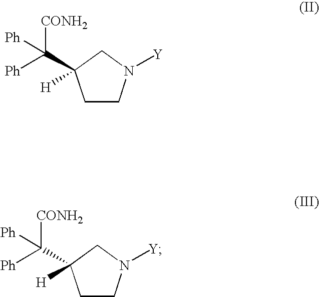

c) eluting the sample from the column with a mobile phase using chromatographic conditions; d) identifying the respective retention times of the enantiomers of formula (II) and (III) or salts thereof, and e) comparing the areas of the peaks associated with the retention times of enantiomers (II) and (III), thereby quantifying the enantiomers, and thereby determining the enantiomeric purity of a compound of formula (I).

In a preferred embodiment, the invention provides a method for differentiating and quantifying the enantiomers, and thus determination of enantiomeric purity, of darifenacin and intermediate compounds used in the preparation of darifenancin. Differentiation and quantification of enantiomers, and thereby determining enantiomeric purity, is performed using high performance liquid chromatography (HPLC) under chromatographic conditions.

It is understood that the phrase “compounds of the formula (II) and (III)” is meant to convey “enantiomers (II) and (III)” as the two phrases, and variations thereof, are used interchangeably herein.

Salts of compounds of formula (I) or of the enantiomers of formulas (II) and (III) are preferably pharmaceutically acceptable salts and are apparent to those skilled in the art. In preferred embodiments of the invention, the salt of the compounds of formula (I), (II), and (III) is the hydrobromide or tartrate salt. For example, illustrative salts of compounds of formula (I) include 2,2-diphenyl-2-[pyrrolidin-3-yl]acetamide tartrate, 2-{1-[2-(2,3-dihydrobenzofuran-5-yl)ethyl]-3-pyrrolidinyl}-2,2-diphenylacetamide tartrate, and 2-{1-[2-(2,3-dihydrobenzofuran-5-yl)ethyl]-3-pyrrolidinyl}-2,2-diphenylacetamide hydrobromide.

In accordance with a preferred embodiment of the invention, Y of a compound of formula (I) is hydrogen or a substituent of the formula:

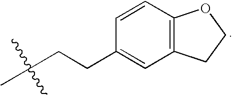

Further, a compound of formula (I) includes any suitable salt form, independent of Y.

In some embodiments, Y is hydrogen, such that a compound of formula (I) is 2,2-diphenyl-2-[pyrrolidin-3-yl]acetamide of the formula:

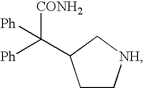

or a salt thereof.

In a preferred embodiment, the compound of formula (I) is 2,2-diphenyl-2-(pyrrolidin-3-yl)acetamide tartrate of the formula:

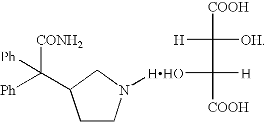

In some embodiments, Y is a substituent of the formula:

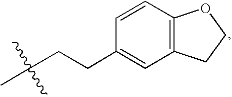

such that a compound of formula (I) is 2-{1-[2-(2,3-dihydrobenzofuran-5-yl)ethyl]-3-pyrrolidinyl}-2,2-diphenylacetamide of the formula:

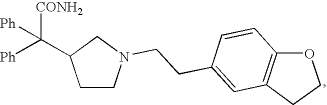

or a salt thereof.

In preferred embodiments, the compound of formula (I) is 2-{1-[2-(2,3-dihydrobenzofuran-5-yl)ethyl]-3-pyrrolidinyl}-2,2-diphenylacetamide hydrobromide or 2-{1-[2-(2,3-dihydrobenzofuran-5-yl)ethyl]-3-pyrrolidinyl}-2,2-diphenylacetamide tartrate. In a particularly preferred embodiment, the compound of formula (I) is 2-{1-[2-(2,3-dihydrobenzofuran-5-yl)ethyl]-3-pyrrolidinyl}-2,2-diphenylacetamide hydrobromide (i.e., darifenacin hydrobromide) of the formula:

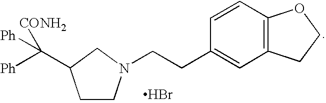

In keeping with one aspect of the invention, it has been found that the differentiation and quantification, and thereby determination of the enantiomeric purity, of compounds of formula (I), (II), and (III) can be performed using chiral high performance liquid chromatography by the selection of a high performance liquid chromatography column capable of separating enantiomers of the compound of formula (I). There are various aspects to chiral HPLC, including for example, the chromatographic conditions used (e.g., normal phase conditions or reverse phase conditions), solvents used for sample preparation, concentration of samples, mobile phase used to elute samples from the column, the choice of column and detector, desired application (e.g., analytical scale, semi-preparative, preparative, etc.), and the like.

In accordance with the invention, the chromatographic conditions can be normal-phase conditions or reverse-phase conditions. As known to the skilled artisan, normal-phase conditions generally refer to conditions in which the stationary phase is more polar than the mobile phase, whereas reverse-phase conditions generally refer to conditions in which the stationary phase is less polar than the mobile phase. Thus, one of ordinary skill further understands that the phase of the chromatographic system influences chromatographic conditions, for example, choice of solvents, mobile phase, and column. It is possible that a compound can be analyzed using both normal-phase and reverse-phase conditions depending on the desired application.

In accordance with the invention, samples comprising a compound of formula (I) can be prepared in any suitable solvent. Suitable sample solvents are apparent to one of ordinary skill, and generally are not critical. The solvent is any suitable organic solvent, non-organic solvent, or mixture thereof in which the sample dissolves such that the sample can be loaded onto the column. The choice of solvent depends, at least in part, on the chromatographic conditions. In some cases, sample solvents used in the invention comprise the mobile phase. In some instances, it may be necessary to use additional solvents other than the mobile phase, as appropriate.

In accordance with the invention, any suitable mobile phase can be utilized. Generally, the mobile phase comprises at least one solvent selected from the group consisting of non-polar solvents, polar aprotic solvents, polar protic solvents, and mixtures thereof. By way of example, suitable mobile phases can include at least one solvent selected from the group consisting of hexane, heptane, methanol, isopropanol, ethanol, acetonitrile, dichloromethane, chloroform, tetrahydrofuran, ethyl acetate, acetone, methyl acetate, MTBE, dimethylformamide, dimethylacetamide, DMSO, water, and mixtures thereof. In a preferred embodiment, the mobile phase comprises at least one solvent selected from the group consisting of hexane, acetonitrile, isopropanol, water, and mixtures thereof. In particularly preferred embodiment, the mobile phase comprises hexane and isopropanol. In another particularly preferred embodiment, the mobile phase comprises acetonitrile and water.

In accordance with the invention, the mobile phase can comprise at least one additive. As known to one of ordinary skill, additives are used to improve resolution by enhancing peak shapes. Typically, additives are acidic compounds, basic compounds, or buffers, depending on the chromatographic conditions which are utilized. The choice of additive depends on several factors including the compound of interest (e.g., acidic or basic) which is being analyzed and the desired application (e.g., normal-phase conditions or reverse-phase conditions). For example, an aqueous buffer (e.g., phosphate buffer) may be used to adjust the pH of a mobile phase system which is to be used under reverse-phase conditions. Similarly, a basic organic compound (e.g., diethylamine) may be added to a mobile phase system which is to be used under normal-phase conditions. In a preferred embodiment, the additive is a basic compound or a buffer. Illustrative basic compounds include diethylamine, ethylenediamine, ethanolamine, and butylamine. In a particularly preferred embodiment, the additive is diethylamine. In other preferred embodiments, the additive is a buffer. In a particularly preferred embodiment, the buffer is a phosphate buffer.

The pH of the mobile phase can be any suitable pH and typically is modified using an aqueous buffer system (e.g., phosphate buffer). The desired pH of the mobile phase depends on several factors, including the compound of interest (e.g., acidic or basic compound) and the desired chromatographic conditions (e.g., reverse-phase). Accordingly, the buffer system must be compatible with the mobile phase system. For example, an aqueous buffer system is not generally suitable for an organic mobile phase. Typically, the pH of the mobile phase is greater than or equal to about 2, and less than or equal to about 9 and can be adjusted by the addition of one or more buffers to the mobile phase. In a preferred embodiment, the pH is greater than or equal to about 2, and less than or equal to about 7. In a particularly preferred embodiment, the pH is about 2.

Samples in accordance with the invention can be prepared at any suitable concentration, which are apparent to those of ordinary skill. Generally, sample concentration is not critical, and will depend, at least in part, on chromatographic conditions and the desired application (e.g., column and scale). Suitable sample concentrations can be determined readily, for example, by calculations known to the skilled artisan. Suitable sample concentrations include for example, 0.5 mg/mL, 1 mg/mL, and 2 mg/mL.

Samples in accordance with the invention can be introduced to the column using any means known in the art (e.g., manual injection or automated sampler), as appropriate. Generally, the method of loading the sample onto the column is not critical, and will depend, at least in part, on the desired application (e.g., single analysis, batch analysis, analytical scale, preparative scale).

Columns used in accordance with the invention comprise stationary phases capable of separating enantiomeric mixtures, for example, a mixture of compounds of formula (II) and (III). In preferred embodiments, columns used in the invention have a chiral stationary phase (CSP). Typically, the CSP comprises polysaccharide derivatives which have been immobilized or coated onto silica. Suitable polysaccharide derivatives include derivatized amylose, derivatized cellulose, and mixtures thereof, as described in, for example, U.S. Pat. No. 5,663,311, which is incorporated herein by reference. Preferably, the polysaccharide derivative is tris-3,5-dimethylphenylcarbamate amylose or tris-3,5-dimethylphenylcarbamate cellulose.

Columns in accordance with the invention are available, for example, under the trademark CHIRALCEL® and CHIRALPAK® by Chiral Technologies, Inc. Several variants of each series are available depending on the desired application. For example, the CHIRALCEL® OD-RH column has a coated CSP that is based on cellulosic backbone comprising a tris-3,5-dimethylphenylcarbamate derivative of cellulose. By way of further illustration, the CHIRALPAK® IA column has an immobilized CSP that is based on amylosic backbone comprising a tris-3,5-dimethylphenylcarbamate derivative of amylose. Each column is available in various lengths (e.g., 100 mm, 150 mm, 250 mm, and 500 mm), internal diameters (e.g., 0.3 mm, 2.1 mm, and 4.6 mm, 10 mm, 21 mm, and 50 mm), and CSP particle size (e.g., 5, 10, and 20 μm) depending on the application (e.g., analytical, semi-preparative, preparative).

In accordance with the invention, samples comprising a compound of formula (I) are eluted from the column. As a sample is eluted from the column, the sample is resolved into its components, including enantiomers of formula (II) and (III) and salts thereof. Not wishing to be bound by theory, it is believed that interactions between the CSP, mobile phase, and the compound of formula (I) result in different retention times for each enantiomer (e.g., compound of formula (II) and (III)). For example, a compound of formula (I) can form hydrogen bonds with the carbamate moieties present in the CSP. The polysaccharide backbone of the CSP exists in a helical conformation, giving rise to steric restrictions that can inhibit access of one enantiomer (e.g., a compound of formula (II) or (III)) to hydrogen bonding sites, thus creating numerous potential enantioselective interactions and large selectivity values. Further, the composition of the mobile phase can affect the separation as different solvents can alter the three-dimensional structure of the CSP. Thus, the composition of the mobile phase can serve as a means for controlling selectivity.

Thus, in accordance with the invention, enantiomers (II) and (III) or salts thereof, have different retention times under a given set of chromatographic conditions. Accordingly, the respective retention times can be identified and the enantiomers differentiated. As known to the skilled artisan, this is typically accomplished by using standard compounds, that is, compounds of known stereochemistry (e.g., the (S)-enantiomer only), or a mixture of known compounds with a known enantiomeric purity (e.g., 95% ee). The respective retention times of each enantiomer is identified using the standard compounds and these retention times can be used to analyze an unknown sample under the same or similar chromatographic conditions.

As known to one of ordinary skill, once the retention times are identified, the area under the curve (AUC) of the corresponding peaks is proportional to the amount of the compound or enantiomer which is present. Accordingly, the enantiomers can be quantified. The AUC of the respective peaks can be compared, thereby determining the enantiomeric purity of a compound of formula (I).

Additional components of the chromatographic system are well-known to the skilled artisan. For example, suitable detectors and their operation are well-known. In addition, software used to operate the HPLC is well-known. Typically, it is this software which is used to identify peaks and determine AUC. The type of detector and means for determining AUC are generally not critical and will vary depending on the instrument and desired application.

In an embodiment, the invention provides a method for differentiating and quantifying the enantiomers, thereby determining the enantiomeric purity, of a compound of formula (I) by chiral high performance liquid chromatography under reverse-phase conditions. More preferably, Y of the compound of formula (I) is hydrogen, the stationary phase of the column comprises a derivatized cellulose and the mobile phase comprises acetonitrile, water, and phosphate buffer, and the pH of the mobile phase is about 2.

In an embodiment, the invention provides a method for differentiating and quantifying the enantiomers, thereby determining the enantiomeric purity, of a compound of formula (I) by chiral high performance liquid chromatography under normal-phase conditions. More preferably, Y of the compound of formula (I) is a substituent of the formula:

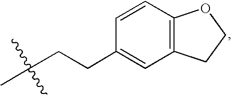

the stationary phase of the column comprises a derivatized amylose and the mobile phase comprises hexane, isopropanol, and diethylamine.

In other embodiments, the inventive method provides for the differentiation and quantification of compounds useful as intermediates in the synthesis of darifenacin and salts thereof, including compounds of varying enantiomeric purity, for example, 2,2-diphenyl-2-[(3S)-pyrrolidin-3-yl]acetamide tartrate, from their corresponding enantiomers, for example, 2,2-diphenyl-2-[(3R)-pyrrolidin-3-yl]acetamide tartrate. In an embodiment, the invention provides a method for the differentiation and quantification of compounds, for example, 2,2-diphenyl-2-[(3S)-pyrrolidin-3-yl]acetamide or salt thereof (e.g., 2,2-diphenyl-2-[(3S)-pyrrolidin-3-yl]acetamide tartrate) having less than about 0.5% by percentage area HPLC of 2,2-diphenyl-2-[(3R)-pyrrolidin-3-yl]acetamide or salt thereof (e.g., 2,2-diphenyl-2-[(3R)-pyrrolidin-3-yl]acetamide tartrate. In a preferred embodiment the percentage area HPLC of 2,2-diphenyl-2-[(3R)-pyrrolidin-3-yl]acetamide is less than 0.1%, more preferably less than 0.01%, most preferably 2,2-diphenyl-2-[(3R)-pyrrolidin-3-yl]acetamide is not detectable by HPLC.

In other embodiments, the inventive method provides for the differentiation and quantification of compounds, including compounds of varying enantiomeric purity, from their corresponding enantiomers, for example, (S)-2-{1-[2-(2,3-dihydrobenzofuran-5-yl)ethyl]-3-pyrrolidinyl}-2,2-diphenylacetamide or a salt thereof (e.g., darifenacin hydrobromide), from (R)-2-(1-(2-(2,3-dihydrobenzofuran-5-yl)ethyl)-3-pyrrolidinyl)-2,2-diphenylacetamide or a salt thereof (e.g., (R)-2-(1-(2-(2,3-dihydrobenzofuran-5-yl)ethyl)-3-pyrrolidinyl)-2,2-diphenylacetamide hydrobromide). In an embodiment, the invention provides a method for the differentiation and quantification of compound (S)-2-{1-[2-(2,3-dihydrobenzofuran-5-yl)ethyl]-3-pyrrolidinyl}-2,2-diphenylacetamide or salt thereof (e.g., (S)-2-{1-[2-(2,3-dihydrobenzofuran-5-yl)ethyl]-3-pyrrolidinyl}-2,2-diphenylacetamide hydrobromide or (S)-2-{1-[2-(2,3-dihydrobenzofuran-5-yl)ethyl]-3-pyrrolidinyl}-2,2-diphenylacetamide tartrate) having less than about 0.5% by percentage area HPLC of (R)-2-(1-(2-(2,3-dihydrobenzofuran-5-yl)ethyl)-3-pyrrolidinyl)-2,2-diphenylacetamide or salt thereof (e.g., (R)-2-{1-[2-(2,3-dihydrobenzofuran-5-yl)ethyl]-3-pyrrolidinyl}-2,2-diphenylacetamide hydrobromide or (R)-2-{1-[2-(2,3-dihydrobenzofuran-5-yl)ethyl]-3-pyrrolidinyl}-2,2-diphenylacetamide tartrate). In a preferred embodiment, the percentage area HPLC of (R)-2-{1-[2-(2,3-dihydrobenzofuran-5-yl)ethyl]-3-pyrrolidinyl}-2,2-diphenylacetamide is less than about 0.1%, more preferably less than about 0.01%, most preferably (R)-2-{1-[2-(2,3-dihydrobenzofuran-5-yl)ethyl]-3-pyrrolidinyl}-2,2-diphenylacetamide is not detectable by HPLC.

In an embodiment, the invention provides a process for preparing (S)-2-{1-[2-(2,3-dihydrobenzofuran-5-yl)ethyl]-3-pyrrolidinyl}-2,2-diphenylacetamide or a salt thereof (e.g., darifenacin hydrobromide) comprising reacting 2,2-diphenyl-2-[(3S)-pyrrolidin-3-yl]acetamide or a salt thereof with a compound of the formula:

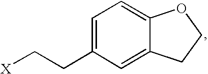

wherein X is a leaving group and wherein the 2,2-diphenyl-2-[(3S)-pyrrolidin-3-yl]acetamide or a salt thereof comprises less than about 0.5% by percentage area HPLC of 2,2-diphenyl-2-[(3R)-pyrrolidin-3-yl]acetamide, as differentiated and quantified according to the inventive method. In a more preferred embodiment, the percentage area HPLC of 2,2-diphenyl-2-[(3R)-pyrrolidin-3-yl]acetamide is less than 0.1%, more preferably less than 0.01%, most preferably 2,2-diphenyl-2-[(3R)-pyrrolidin-3-yl]acetamide is not detectable by HPLC

In accordance with the invention, X of the compound of formula:

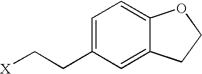

can be any suitable leaving group. Typically, the leaving group is a halogen or a sulfonate ester. Preferably, the leaving group is selected from the group consisting of fluorine, chlorine, bromine, iodine, mesylate, tosylate, nosylate, and brosylate. More preferably, the leaving group is a halogen. Most preferably, the leaving group is bromine.

The following examples further illustrate the invention but, of course, should not be construed as in any way limiting its scope.

### EXAMPLE 1

This example illustrates a method for differentiating and quantifying the enantiomers, thereby determining the enantiomeric purity of a compound of formula (I). In particular, this example illustrates a method for differentiating and quantifying the enantiomers of 2,2-diphenyl-2-[pyrrolidin-3-yl]acetamide tartrate using reverse-phase conditions.

A mobile phase is prepared by mixing 300 mL of acetonitrile with 700 mL of buffer (pH 2). The buffer is prepared from 18.40 g of hexafluorophosphate in 1000 mL of water adjusting the pH to 2 with phosphoric acid. The mobile phase is mixed and filtered through 0.22 μm nylon membrane under vacuum.

Samples comprising 2,2-diphenyl-2-[(3S)-pyrrolidin-3-yl]acetamide tartrate, 2,2-diphenyl-2-[(3R)-pyrrolidin-3-yl]acetamide tartrate, and mixtures comprising a 1:1 mixture of the enantiomers are prepared at a concentration of 0.5 mg per mL using the mobile phase as the solvent. Ten microliters of the samples are loaded onto a chiral HPLC column (Daicel CHIRALCEL® OD-RH, 5 μm, 4.6×150 mm) and eluted for at least 30 minutes at a flow rate of 0.5 mL per minute at room temperature (20-25° C.). The chromatograph is equipped with a detector monitoring at 210 nm.

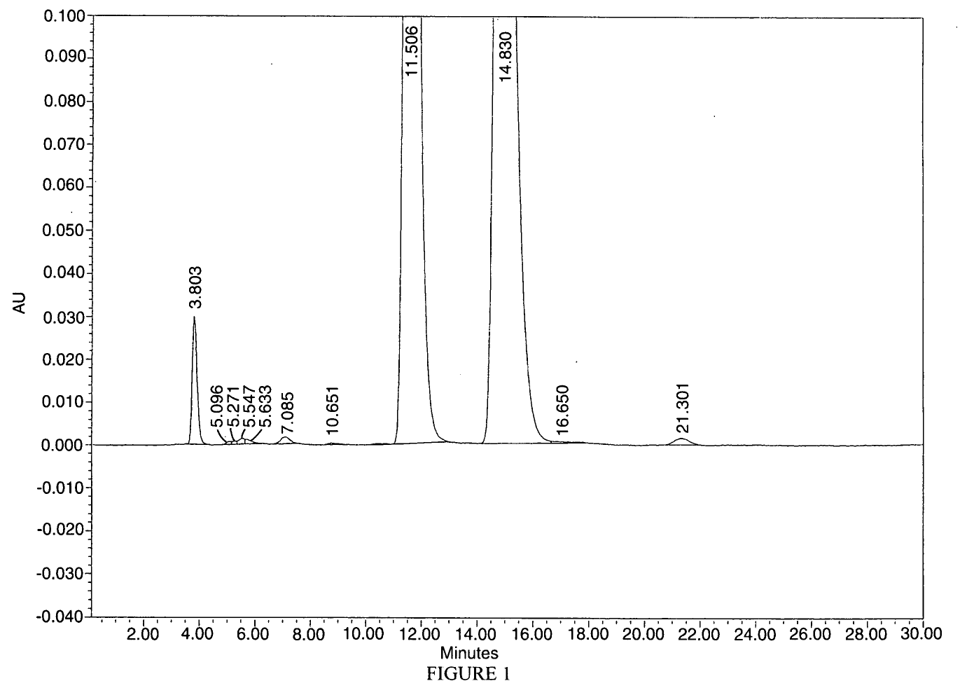

FIG. 1 is a HPLC chromatogram of a reference sample comprising a racemic mixture of 2,2-diphenyl-2-(pyrrolidin-3-yl)acetamide tartrate analyzed using these conditions. The peaks for each enantiomer are listed below in Table 1.

TABLE 1

| Peak | Retention Time (minutes) | % Area |
|---|---|---|
| 1 | 3.8 | 1.6 |
| 2 | 11.5 | 47.8 |
| 3 | 14.8 | 49.9 |

The data from FIG. 1 can be used to differentiate and identify the retention times of 2,2-diphenyl-2-[(3S)-pyrrolidin-3-yl]acetamide tartrate and 2,2-diphenyl-2-[(3R)-pyrrolidin-3-yl]acetamide tartrate from a 1:1 mixture as a reference sample. The peak at 11.5 minutes corresponds to 2,2-diphenyl-2-[(3S)-pyrrolidin-3-yl]acetamide tartrate. The peak at 14.8 minutes corresponds to 2,2-diphenyl-2-[(3R)-pyrrolidin-3-yl]acetamide tartrate. The peak at 3.8 minutes corresponds to tartrate.

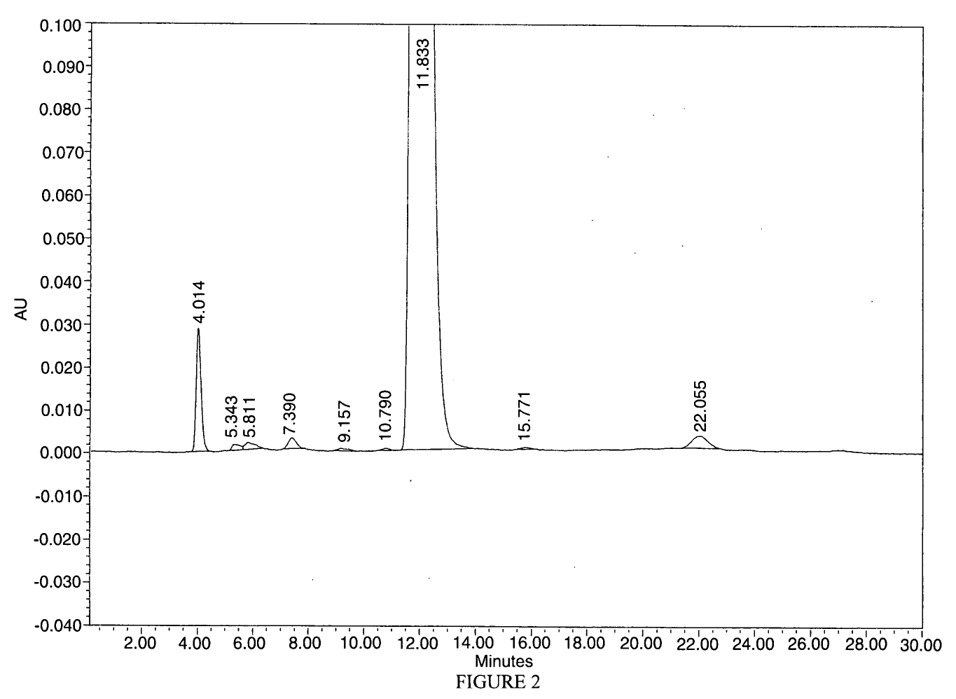

FIG. 2 is a HPLC chromatogram of a sample comprising 2,2-diphenyl-2-[(3S)-pyrrolidin-3-yl]acetamide tartrate analyzed using these conditions. The peak for the (S)-enantiomer is listed below in Table 2.

TABLE 2

| Peak | Retention Time (minutes) | % Area |
|---|---|---|
| 1 | 4.0 | 1.5 |
| 2 | 11.8 | 97.3 |

The data from FIG. 2 can be used to determine the enantiomeric purity of 2,2-diphenyl-2-[(3S)-pyrrolidin-3-yl]acetamide tartrate. The peak at 11.8 minutes corresponds to 2,2-diphenyl-2-[(3S)-pyrrolidin-3-yl]acetamide tartrate. The enantiomeric purity of 2,2-diphenyl-2-[(3S)-pyrrolidin-3-yl]acetamide tartrate was quantified to be 99.91% ee. The peak at 4.0 minutes corresponds to tartrate.

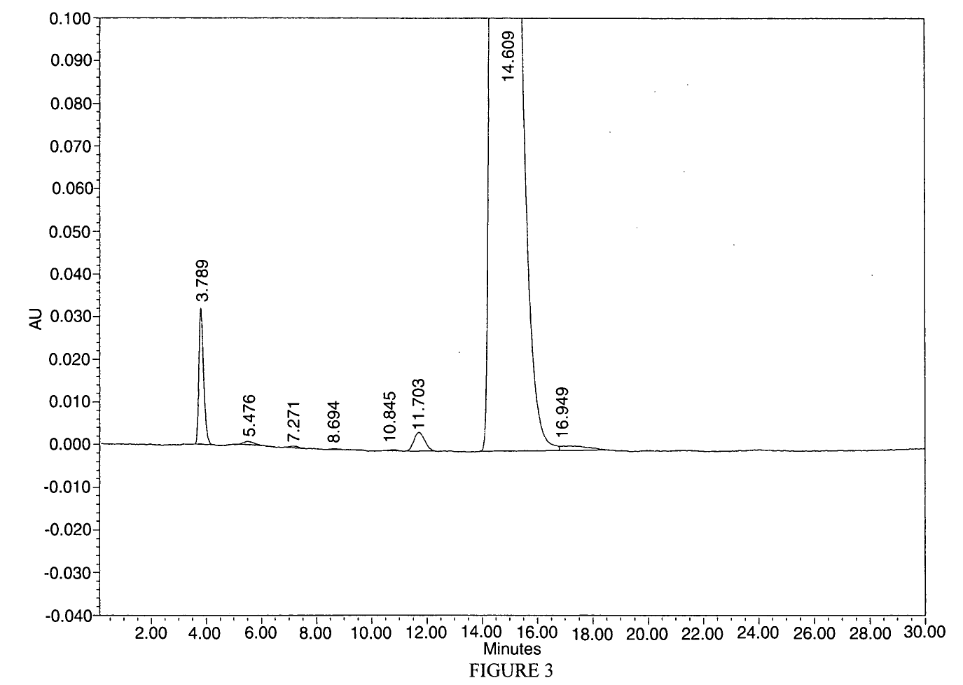

FIG. 3 is a HPLC chromatogram of a sample comprising 2,2-diphenyl-2-[(3R)-pyrrolidin-3-yl]acetamide tartrate analyzed using these conditions. The peak for the (R)-enantiomer is listed below in Table 3.

TABLE 3

| Peak | Retention Time (minutes) | % Area |
|---|---|---|
| 1 | 3.8 | 1.6 |
| 2 | 14.6 | 97.4 |

The data from FIG. 3 can be used to determine enantiomeric purity of 2,2-diphenyl-2-[(3R)-pyrrolidin-3-yl]acetamide tartrate. The peak at 14.6 minutes corresponds to 2,2-diphenyl-2-[(3R)-pyrrolidin-3-yl]acetamide tartrate. The enantiomeric purity of 2,2-diphenyl-2-[(3R)-pyrrolidin-3-yl]acetamide tartrate was quantified to be 98.97% ee. The peak at 3.8 minutes corresponds to tartrate.

### EXAMPLE 2

This example illustrates a method for differentiating and quantifying the enantiomers, thereby determining the enantiomeric purity of a compound of formula (I). In particular, this example illustrates a method for differentiating and quantifying the enantiomers of 2-{1-[2-(2,3-dihydrobenzofuran-5-yl)ethyl]-3-pyrrolidinyl}-2,2-diphenylacetamide hydrobromide using normal phase conditions.

A mobile phase is prepared by mixing 600 mL of hexane and 400 mL of isopropanol with 1 mL of diethylamine. The mobile phase is mixed and filtered through 0.22 μm nylon membrane under vacuum.

Samples comprising darifenacin hydrobromide, the (R)-enantiomer of darifenacin hydrobromide, and a racemic mixture of darifenacin hydrobromide are prepared at a concentration of 1.0 mg per mL using a mixture of hexane/isopropanol/diethylamine (60:40:1) as the solvent. Forty microliters of the sample is loaded onto a chiral HPLC column (Daicel CHIRALPAK IA®, 5 μm, 4.6×250 mm) and eluted for at least 30 minutes at a flow rate of 1.0 mL per minute at room temperature (20-25° C.). The chromatograph is equipped with a detector monitoring at 230 nm.

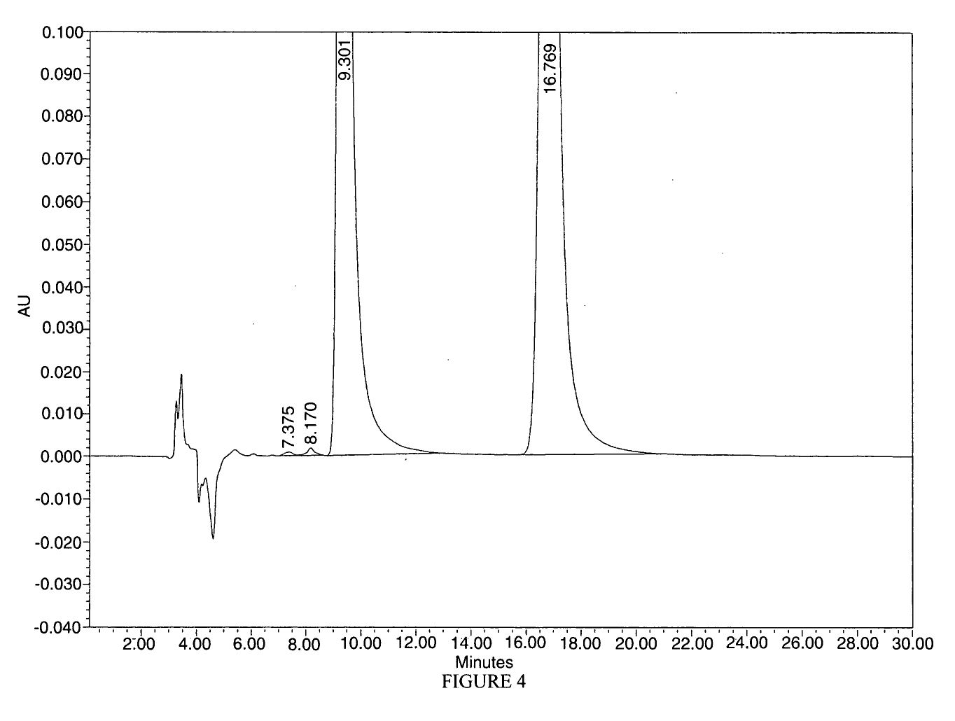

FIG. 4 is a HPLC chromatogram of a sample comprising a racemic mixture of darifenacin hydrobromide analyzed using these conditions. The peaks for each enantiomer are listed below in Table 4.

TABLE 4

| Peak | Retention Time (minutes) | % Area |
|---|---|---|
| 1 | 9.3 | 48.0 |
| 2 | 16.8 | 51.8 |

The data from FIG. 4 can be used to differentiate and identify the retention times of both enantiomers of 2-{1-[2-(2,3-dihydrobenzofuran-5-yl)ethyl]-3-pyrrolidinyl}-2,2-diphenylacetamide hydrobromide from a racemic mixture. The peak at 9.3 minutes corresponds to the (R)-enantiomer and the peak at 16.8 minutes corresponds to the (S)-enantiomer.

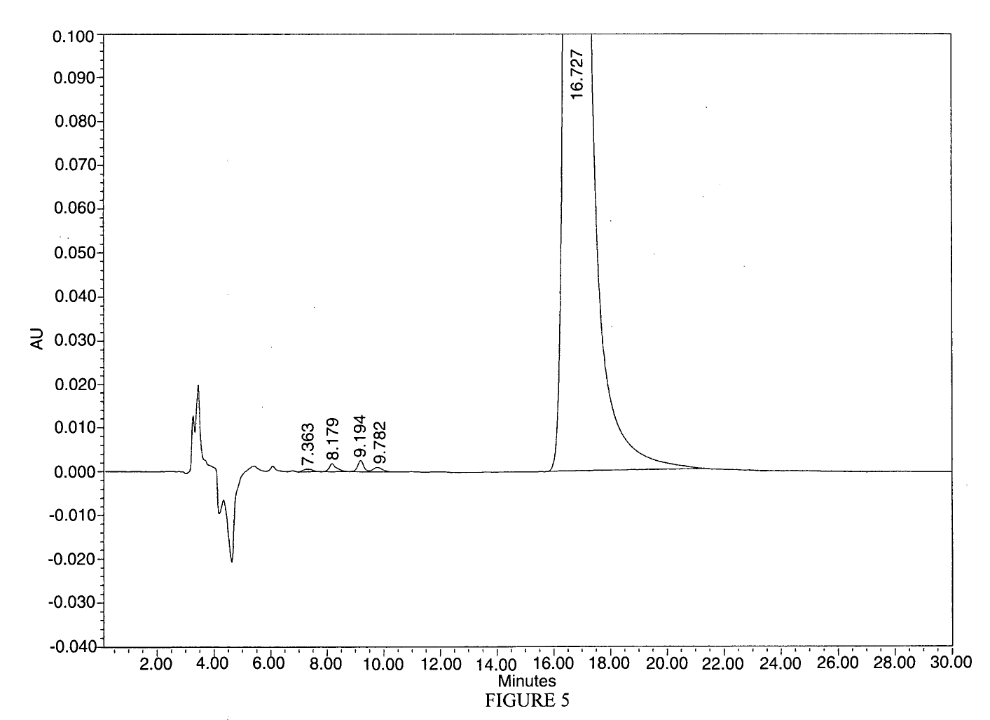

FIG. 5 is a HPLC chromatogram of a sample comprising (S)-darifenacin hydrobromide analyzed using these conditions. The peak for (S)-darifenacin is listed below in Table 5.

TABLE 5

| Peak | Retention Time (minutes) | % Area |
|---|---|---|
| 1 | 16.7 | 99.6 |

The data from FIG. 5 can be used to determine the enantiomeric purity of the (S)-enantiomer of 2-{1-[2-(2,3-dihydrobenzofuran-5-yl)ethyl]-3-pyrrolidinyl}-2,2-diphenylacetamide hydrobromide (i.e., darifenacin hydrobromide). The peak at 16.7 minutes corresponds to darifenacin hydrobromide. The enantiomeric purity of darifenacin hydrobromide was quantified to be 99.70% ee.

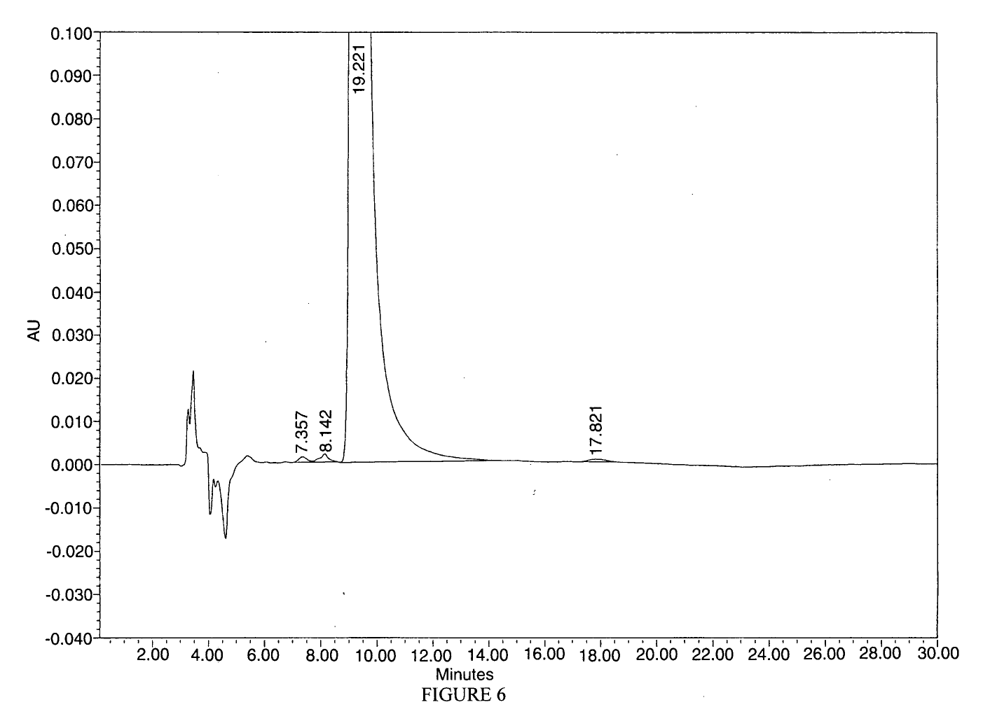

FIG. 6 is a HPLC chromatogram of a sample comprising (R)-darifenacin hydrobromide analyzed using these conditions. The peak for (R)-darifenacin is listed below in Table 6.

TABLE 6

| Peak | Retention Time (minutes) | % Area |
|---|---|---|
| 1 | 9.2 | 99.6 |

The data from FIG. 6 demonstrates a method for identifying the retention time of the (R)-enantiomer of 2-{1-[2-(2,3-dihydrobenzofuran-5-yl)ethyl]-3-pyrrolidinyl}-2,2-diphenylacetamide hydrobromide (i.e., (R)-enantiomer of darifenacin hydrobromide). The peak at 9.2 minutes corresponds to the (R)-enantiomer of darifenacin hydrobromide. The enantiomeric purity of the (R)-enantiomer of darifenacin hydrobromide was quantified to be 99.67% ee.

### EXAMPLE 3

This example illustrates a process for preparing (S)-2-{1-[2-(2,3-dihydrobenzofuran-5-yl)ethyl]-3-pyrrolidinyl}-2,2-diphenylacetamide or a salt thereof wherein a substantially enantiomerically pure 2,2-diphenyl-2-[(3S)-pyrrolidin-3-yl]acetamide or salt thereof, as determined by the inventive method, is used as an intermediate compound. In particular, this example illustrates that when using 2,2-diphenyl-2-[(3S)-pyrrolidin-3-yl]acetamide having less than 0.2% of the (R)-enantiomer as determined by the HPLC method of Example 1, the obtained (S)-darifenacin hydrobromide has less than 0.06% of the (R)-enantiomer of darifenacin hydrobromide as determined by the HPLC method of Example 2.

To a flask was added: 2,2-diphenyl-2-[(3S)-pyrrolidin-3-yl]acetamide (54.15 g, 125.8 mmol, 99.63% ee as determined by chiral HPLC method of Example 1), 5-(2-bromoethyl)-2,3-dihydrobenzofuran (34.86 g, 153.5 mmol), potassium hydroxide (20.78 g, 370.4 mmol), methyltriethylammonium chloride (2.810 g, 18.53 mmol), methylethylketone (170 mL) and water (34.0 mL). The reaction mixture was heated to reflux (approximately 75° C.) and stirred for 6 hours, after which time the reaction mixture was cooled to 20-25° C. After cooling, methylethylketone (96 mL) and water (106 mL) were added with stirring and the layers were separated. Ammonium chloride (106 mL, 10% aqueous solution) was added to the organic layer with stirring and the layers were separated. The organic layer was evaporated to dryness and methylethylketone (106 mL) was added to the residue. The mixture was stirred until dissolution and hydrobromic acid (13 mL) was added, after which a precipitate formed. The resulting suspension was cooled to 0-5° C. and stirred at this temperature for 2 hours. The suspension was filtered and the solid was washed with methylethylketone (2×20 mL). A solid was obtained (90.72 g, l.o.d.=41.51%, 84.92% yield, 95.68% HPLC purity, 99.88% ee as determined by chiral HPLC method of Example 2).

### EXAMPLE 4

This example illustrates a method for differentiating and quantifying the enantiomers, thereby determining the enantiomeric purity of 2-{1-[2-(2,3-dihydrobenzofuran-5-yl)ethyl]-3-pyrrolidinyl}-2,2-diphenylacetamide hydrobromide using normal phase conditions.

A mobile phase is prepared by mixing 100 mL of hexane and 900 mL of a solution of 0.1% of diethylamine in isopropanol. The mobile phase is mixed and filtered through 0.22 μm nylon membrane under vacuum.

Samples comprising darifenacin hydrobromide, the (R)-enantiomer of darifenacin hydrobromide, and a racemic mixture of darifenacin hydrobromide are prepared at a concentration of 2.0 mg per mL using a mixture of hexane/isopropanol/diethylamine (10:89.1:0.9) as the solvent. Ten microliters of the sample are loaded onto a chiral HPLC column (Daicel CHIRALPAK IA®, 5 μm, 4.6×250 mm) and eluted for at least 30 minutes at a flow rate of 0.7 mL per minute at room temperature (20-25° C.). The chromatograph is equipped with a detector monitoring at 230 nm.

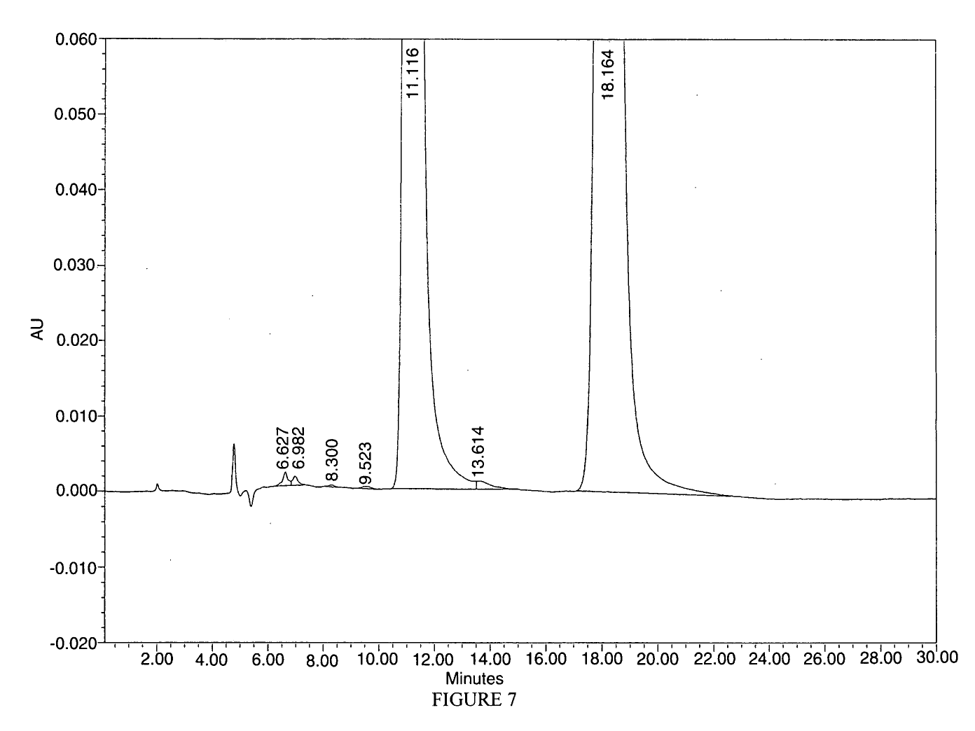

FIG. 7 is a HPLC chromatogram of a sample comprising a racemic mixture of darifenacin hydrobromide analyzed using these conditions. The peaks for each enantiomer are listed below in Table 7.

TABLE 7

| Peak | Retention Time (minutes) | % Area |
|---|---|---|
| 1 | 11.1 | 49.0 |
| 2 | 18.2 | 50.8 |

The data from FIG. 7 can be used to differentiate and identify the retention times of both enantiomers of 2-{1-[2-(2,3-dihydrobenzofuran-5-yl)ethyl]-3-pyrrolidinyl}-2,2-diphenylacetamide hydrobromide from a racemic mixture. The peak at 11.1 minutes corresponds to the (R)-enantiomer and the peak at 18.2 minutes corresponds to the (S)-enantiomer.

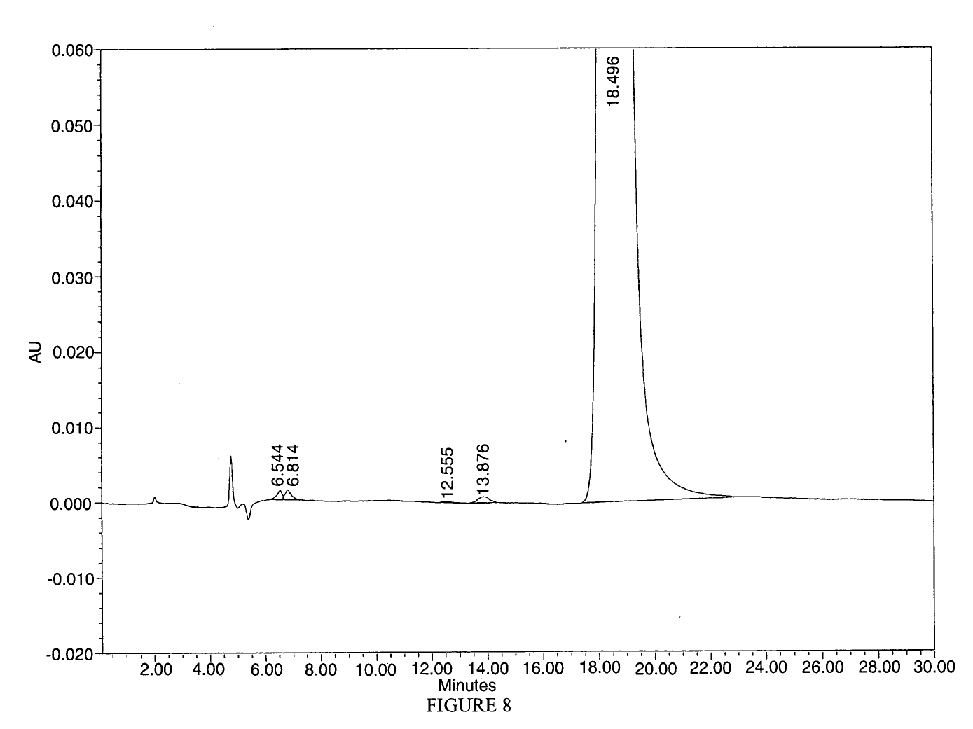

FIG. 8 is a HPLC chromatogram of a sample (S)-darifenacin hydrobromide analyzed using these conditions. The peak for (S)-darifenacin hydrobromide is listed below in Table 8.

TABLE 8

| Peak | Retention Time (minutes) | % Area |
|---|---|---|
| 1 | 18.5 | 99.8 |

The data from FIG. 8 can be used to determine the enantiomeric purity of the (S)-enantiomer of 2-{1-[2-(2,3-dihydrobenzofuran-5-yl)ethyl]-3-pyrrolidinyl}-2,2-diphenylacetamide hydrobromide (i.e., darifenacin hydrobromide). The peak at 18.5 minutes corresponds to darifenacin hydrobromide (>99.90% ee).

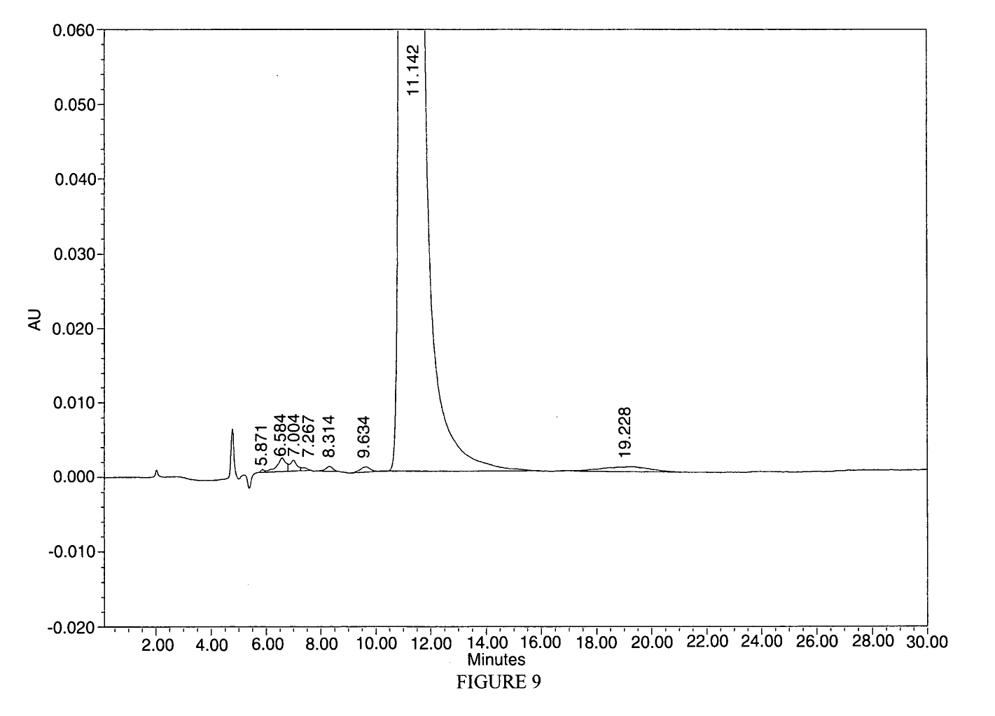

FIG. 9 is a HPLC chromatogram of a sample comprising (R)-darifenacin hydrobromide analyzed using these conditions. The peak for (R)-darifenacin hydrobromide is listed below in Table 9.

TABLE 9

| Peak | Retention Time (minutes) | % Area |
|---|---|---|
| 7 | 11.1 | 99.4 |

The data from FIG. 9 can be used to determine the enantiomeric purity of the (R)-enantiomer of 2-{1-[2-(2,3-dihydrobenzofuran-5-yl)ethyl]-3-pyrrolidinyl}-2,2-diphenylacetamide hydrobromide (i.e., (R)-enantiomer of darifenacin hydrobromide). The peak at 11.1 minutes corresponds to the (R)-enantiomer of darifenacin hydrobromide (99.17% ee).

All references, including publications, patent applications, and patents, cited herein are hereby incorporated by reference to the same extent as if each reference were individually and specifically indicated to be incorporated by reference and were set forth in its entirety herein.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for determining the enantiomeric purity of a compound of formula (I): 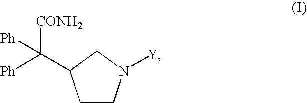
or a salt thereof, wherein Y is hydrogen or a substituent of the formula: 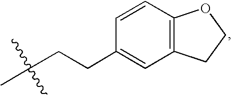
comprising:
a) preparing a sample comprising a compound of formula (I);
b) introducing the sample to a chiral high performance liquid chromatography column comprising a stationary phase capable of separating enantiomers of the compound of formula (I), wherein the enantiomers of the compound of formula (I) are compounds of the formula (II) and (III) or salts thereof: 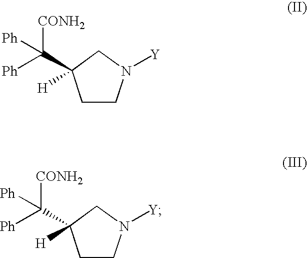
c) eluting the sample from the column with a mobile phase using chromatographic conditions;
d) identifying the respective retention times of the enantiomers of formula (II) and (III) or salts thereof; and
e) comparing the areas of the peaks associated with the retention times of enantiomers (II) and (III), thereby quantifying the enantiomers, and thereby determining the enantiomeric purity of a compound of formula (I).

2. The method of claim 1, wherein the salt of any of the compounds of formula I, formula II, or formula III is the hydrobromide or tartrate salt.

3. The method of claim 2, wherein Y is hydrogen.

4. The method of claim 2, wherein Y is a substituent of the formula:

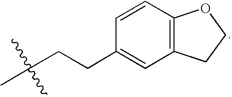

5. The method of claim 3, wherein the compound of formula (I) is 2,2-diphenyl-2-(pyrrolidin-3-yl)acetamide tartrate of the formula:

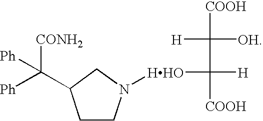

6. The method of claim 4, wherein the compound of formula (I) is 2-{1-[2-(2,3-dihydrobenzofuran-5-yl)ethyl]-3-pyrrolidinyl}-2,2-diphenylacetamide hydrobromide of the formula:

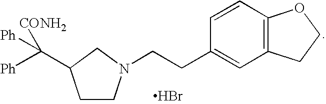

7. The method of claim 1, wherein the column comprises at least one polysaccharide as a stationary phase.

8. The method of claim 7, wherein the polysaccharide is selected from the group consisting of derivatized amylose, derivatized cellulose, and mixtures thereof.

9. The method of claim 1, wherein the mobile phase comprises at least one solvent selected from the group consisting of non-polar solvents, polar aprotic solvents, polar protic solvents, and mixtures thereof.

10. The method of claim 9, wherein the solvent is selected from the group consisting of hexane, acetonitrile, isopropanol, water, and mixtures thereof.

11. The method of claim 10, wherein the mobile phase further comprises at least one additive.

12. The method of claim 11, wherein the additive is diethylamine.

13. The method of claim 11, wherein the additive is a buffer.

14. The method of claim 13, wherein the buffer is a phosphate buffer.

15. The method of claim 3, wherein the chromatographic conditions are reverse-phase conditions.

16. The method of claim 15, wherein the stationary phase of the column comprises a derivatized cellulose and the mobile phase comprises acetonitrile, water, and phosphate buffer, and the pH of the mobile phase is about 2.

17. The method of claim 4, wherein the chromatographic conditions are normal-phase conditions.

18. The method of claim 17, wherein the stationary phase of the column comprises a derivatized amylose and the mobile phase comprises hexane, isopropanol, and diethylamine.

19. The compound (S)-2-{1-[2-(2,3-dihydrobenzofuran-5-yl)ethyl]-3-pyrrolidinyl}-2,2-diphenylacetamide or salt thereof having less than about 0.5% by percentage area HPLC of (R)-2-(1-(2-(2,3-dihydrobenzofuran-5-yl)ethyl)-3-pyrrolidinyl)-2,2-diphenylacetamide, as determined by the method of claim 4.

20. The (S)-2-{1-[2-(2,3-dihydrobenzofuran-5-yl)ethyl]-3-pyrrolidinyl}-2,2-diphenylacetamide or salt thereof of claim 19 having less than about 0.1% by percentage area HPLC of (R)-2-(1-(2-(2,3-dihydrobenzofuran-5-yl)ethyl)-3-pyrrolidinyl)-2,2-diphenylacetamide.

21. The (S)-2-{1-[2-(2,3-dihydrobenzofuran-5-yl)ethyl]-3-pyrrolidinyl}-2,2-diphenylacetamide or salt thereof of claim 20 having less than about 0.01% by percentage area HPLC of (R)-2-(1-(2-(2,3-dihydrobenzofuran-5-yl)ethyl)-3-pyrrolidinyl)-2,2-diphenylacetamide.

22. The (S)-2-{1-[2-(2,3-dihydrobenzofuran-5-yl)ethyl]-3-pyrrolidinyl}-2,2-diphenylacetamide or salt thereof of claim 19, wherein the (S)-2-{1-[2-(2,3-dihydrobenzofuran-5-yl)ethyl]-3-pyrrolidinyl}-2,2-diphenylacetamide is (S)-2-{1-[2-(2,3-dihydrobenzofuran-5-yl)ethyl]-3-pyrrolidinyl}-2,2-diphenylacetamide hydrobromide.

23. The (S)-2-{1-[2-(2,3-dihydrobenzofuran-5-yl)ethyl]-3-pyrrolidinyl}-2,2-diphenylacetamide or salt thereof of claim 19, wherein the (S)-2-{1-[2-(2,3-dihydrobenzofuran-5-yl)ethyl]-3-pyrrolidinyl}-2,2-diphenylacetamide is (S)-2-{1-[2-(2,3-dihydrobenzofuran-5-yl)ethyl]-3-pyrrolidinyl}-2,2-diphenylacetamide tartrate.

24. The compound 2,2-diphenyl-2-[(3S)-pyrrolidin-3-yl]acetamide or salt thereof having less than about 0.5% by percentage area HPLC of 2,2-diphenyl-2-[(3R)-pyrrolidin-3-yl]acetamide, as determined by the method of claim 3.

25. The compound 2,2-diphenyl-2-[(3S)-pyrrolidin-3-yl]acetamide or salt thereof of claim 24 having less than about 0.1% by percentage area HPLC of 2,2-diphenyl-2-[(3R)-pyrrolidin-3-yl]acetamide.

26. The compound 2,2-diphenyl-2-[(3S)-pyrrolidin-3-yl]acetamide or salt thereof of claim 25 having less than about 0.01% by percentage area HPLC of 2,2-diphenyl-2-[(3R)-pyrrolidin-3-yl]acetamide.

27. The 2,2-diphenyl-2-[(3S)-pyrrolidin-3-yl]acetamide or salt thereof of claim 24, wherein the 2,2-diphenyl-2-[(3S)-pyrrolidin-3-yl]acetamide is 2,2-diphenyl-2-[(3S)-pyrrolidin-3-yl]acetamide tartrate.

28. A process for preparing (S)-2-{1-[2-(2,3-dihydrobenzofuran-5-yl)ethyl]-3-pyrrolidinyl}-2,2-diphenylacetamide or salt thereof comprising reacting 2,2-diphenyl-2-[(3S)-pyrrolidin-3-yl]acetamide or a salt thereof of claim 24 with a compound of the formula: 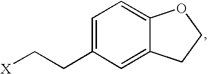
wherein X is a leaving group selected from the group consisting of fluorine, chlorine, bromine, iodine, mesylate, tosylate, nosylate, and brosylate.

29. The process of claim 28, wherein the 2,2-diphenyl-2-[(3S)-pyrrolidin-3-yl]acetamide or salt thereof has less than about 0.1% by percentage area HPLC 2,2-diphenyl-2-[(3R)-pyrrolidin-3-yl]acetamide.

30. The process of claim 29, wherein the 2,2-diphenyl-2-[(3S)-pyrrolidin-3-yl]acetamide or salt thereof has less than about 0.01% by percentage area HPLC 2,2-diphenyl-2-[(3R)-pyrrolidin-3-yl]acetamide.
